(19) United States
(12) Patent Application Publication
(10) Pub. No.: US 2026/0336146 A1
(43) Pub. Date: Oct. 29, 2026

(54) PROCESSING APPARATUS

(71) Applicant: ZHUHAI QUIN TECHNOLOGY CO., LTD, ZHUHAI (CN)

(72) Inventors: JIHONG LIU, ZHUHAI (CN); XIAOWEI WANG, ZHUHAI (CN); JINPENG GUO, ZHUHAI (CN)

(21) Appl. No.: 19/706,020

(22) Filed: Jun. 12, 2026

Related U.S. Application Data
(63) Continuation of application No. PCT/CN2024/139299, filed on Dec. 13, 2024.

(30) Foreign Application Priority Data
Dec. 14, 2023 (CN) 202311734985.6

(51) Int. Cl. B26D 5/00; B26F 1/44

(52) U.S. Cl. CPC B26D 5/007; B26F 1/44

(57) ABSTRACT

A processing apparatus includes: a housing, a first sensor, a second sensor, a transmission assembly, and a moving assembly. The housing includes a first sidewall, a second sidewall, and a third sidewall. The first sensor and the second sensor are disposed on the third sidewall. The transmission assembly is drivingly connected to the moving assembly. The transmission assembly is configured to drive the moving assembly to move between the first sidewall and the second sidewall. When the moving assembly moves to a position directly in front of the first sensor, the first sensor is blocked, and the processing apparatus controls the moving assembly to stop moving toward the first sidewall. When the moving assembly moves to a position directly in front of the second sensor, the second sensor is blocked, and the processing apparatus controls the moving assembly to stop moving toward the second sidewall.

### TECHNICAL FIELD

The present disclosure relates to a field of cutting technology, and in particular to a processing apparatus with low operating noise.

### BACKGROUND

A cutting plotter, also referred to as a contour cutting plotter or a die-cutting machine, is mainly configured for die-cutting (full-cutting, half-cutting), creasing, and foil stamping of thin materials (thin sheets) such as kraft paper, self-adhesive stickers, car stickers, wall stickers, and instant stickers. Main components of the cutting plotter comprise a die-cutting table, a pressing-and-cutting mechanism, and a motor driving the pressing-and-cutting mechanism to move. When in use, a user needs to place a thin sheet on the die-cutting table, and then a contour positioning mechanism on the die-cutting table positions the thin sheet. The motor drives the pressing-and-cutting mechanism to reciprocate, thereby pressing and engraving a predetermined pattern on the thin sheet according to a predetermined die-cutting program.

The inventors have noticed that the motor installed in the cutting plotter typically drives the pressing-and-cutting mechanism to move and strike against a first sidewall of the die-cutting table. After striking against the first sidewall, the motor drives the pressing-and-cutting mechanism to move toward a second sidewall disposed opposite to the first sidewall. After the pressing-and-cutting mechanism strikes against the second sidewall, the motor drives the pressing-and-cutting mechanism to move toward the first sidewall again, thereby completing a reciprocating movement of the pressing-and-cutting mechanism. As a result, the cutting plotter continuously generates wall-striking noise during operation, which affects user experience. Meanwhile, repeatedly striking the first sidewall and the second sidewall also shortens the service life of the die-cutting table and the pressing-and-cutting mechanism.

Therefore, how to provide a cutting plotter capable of preventing the pressing-and-cutting mechanism from striking against sidewalls while achieving precise positioning of the pressing-and-cutting mechanism is an urgent problem to be solved.

### SUMMARY

To address deficiencies of the prior art, the present disclosure provides a processing apparatus featuring anti-striking walls, low noise, precise workpiece positioning, and high processing efficiency.

The processing apparatus comprises: a housing, a first sensor, a second sensor, a transmission assembly, and a moving assembly.

The housing comprises a first sidewall, a second sidewall, and a third sidewall. The first sidewall and the second sidewall are disposed opposite to each other. The third sidewall connects the first sidewall and the second sidewall. The first sensor and the second sensor are disposed on the third sidewall, and the first sensor is adjacent to the first sidewall. The second sensor is adjacent to the second sidewall. The transmission assembly is drivingly connected to the moving assembly, and the transmission assembly is configured to drive the moving assembly to move between the first sidewall and the second sidewall.

When the moving assembly moves to a position directly in front of the first sensor, the first sensor is blocked, and the processing apparatus controls the moving assembly to stop moving toward the first sidewall. When the moving assembly moves to a position directly in front of the second sensor, the second sensor is blocked, and the processing apparatus controls the moving assembly to stop moving toward the second sidewall.

In one optional embodiment, when the moving assembly moves to the position directly in front of the first sensor, the first sensor is blocked, and the processing apparatus controls the moving assembly to stop moving toward the first sidewall and controls the moving assembly to stop or controls the moving assembly to move toward the second sidewall. When the moving assembly moves to the position directly in front of the second sensor, the second sensor is blocked, and the processing apparatus controls the moving assembly to stop moving toward the second sidewall and controls the moving assembly to stop or controls the moving assembly to move toward the first sidewall.

In one optional embodiment, the processing apparatus further comprises a worktable. The housing is connected to the worktable. A first limiting portion and a second limiting portion are disposed on the worktable. The first limiting portion and the second limiting portion are opposite to each other to define a working area of the worktable. The first limiting portion comprises a first limiting plate, and the second limiting portion comprises a second limiting plate. The first limiting plate is disposed on one side of the first limiting portion and extends toward the second limiting portion. The second limiting plate is disposed on one side of the second limiting portion and extends toward the first limiting portion.

In one optional embodiment, a predetermined distance is defined between the working area and each of the first limiting plate and the second limiting plate. The first limiting plate and the second limiting plate are configured to limit a thickness of an external workpiece entering the working area.

In one optional embodiment, the processing apparatus further comprises a third sensor a fourth sensor, and a conveying roller. The third sensor, the fourth sensor, and the conveying roller are disposed on the worktable. The third sensor is located below the first limiting plate. The fourth sensor is located below the second limiting plate. The conveying roller is disposed adjacent to the working area. The processing apparatus has a pre-working state and a working state, and the processing apparatus is switchable between the pre-working state and the working state. When the processing apparatus is in the pre-working state, and when the external workpiece enters the working area and blocks the third sensor and the fourth sensor, the conveying roller rotates in a forward direction to draw in the external workpiece and drive the external workpiece to move.

In one optional embodiment, two ends of the conveying roller are respectively connected to the first sidewall and the second sidewall. A fifth sensor is disposed on the working area. The fifth sensor is close to an inner side of the working area. When the processing apparatus is in the pre-working state, and when the external workpiece enters the working area and blocks the third sensor and the fourth sensor, the conveying roller rotates to draw in and convey the external workpiece. When the external workpiece is conveyed to the inner side of the working area and blocks the fifth sensor, the processing apparatus controls the conveying roller to stop rotating. When the fifth sensor is blocked for a predetermined time, the processing apparatus switches from the pre-working state to the working state, and the conveying roller is switchable among three states of forward rotation, reverse rotation, and a non-rotating state.

In one optional embodiment, the processing apparatus further comprises a first guide rod, a driving roller, and a second guide rod. The first guide rod, the driving roller, and the second guide rod are parallel to each other and are disposed from top to bottom. Two ends of the first guide rod are respectively connected to the first sidewall and the second sidewall. Two ends of the second guide rod are respectively connected to the first sidewall and the second sidewall. Two ends of the driving roller are respectively rotatably connected to the first sidewall and the second sidewall. The moving assembly is movably connected to the first guide rod and the second guide rod. The first guide rod is located at a rear side of the moving assembly. The moving assembly is movable along the first guide rod, the driving roller, and the second guide rod.

In one optional embodiment, the moving assembly comprises a moving piece, a tool, and a mounting base. The driving roller and the second guide rod pass through the moving piece. The moving piece is movably connected to the mounting base. The tool is clamped in the mounting base. The driving roller rotates to drive the mounting base to move up and down, thereby causing the tool to move up and down. During a movement of the moving assembly, an orthographic projection of the tool always falls within the working area.

In one optional embodiment, the moving assembly further comprises an L-shaped baffle. The L-shaped baffle is disposed at an upper portion of one side of the moving assembly close to the third sidewall. The L-shaped baffle and the one side of the moving assembly close to the third sidewall jointly define a limiting space. A portion of the first guide rod is clamped within the limiting space.

In one optional embodiment, the transmission assembly comprises a motor, a transmission belt, a driving wheel, and at least one driven wheel. The transmission belt is drivenly connected to the driving wheel and the at least one driven wheel. The motor is connected to an output shaft of the driving wheel.

The motor is rotatable in a forward direction or a reverse direction, and the motor rotates to drive the driving wheel to rotate, thereby driving the transmission belt and the at least one driven wheel to rotate. Tooth grooves are disposed on an inner side surface of the transmission belt. The moving assembly further comprises a second mounting plate. Engaging teeth are disposed on an inner side surface of the second mounting plate, and the second mounting plate is disposed at a rear side of the moving piece. The second mounting plate is connected to the moving piece to define a positioning space. The transmission belt passes through the positioning space. The tooth grooves of the transmission belt are engaged with the engaging teeth of the second mounting plate.

The processing apparatus of the present disclosure introduces the first sensor and the second sensor. When the moving assembly moves to the position directly in front of the first sensor, the first sensor is blocked, so that a signal from the first sensor is not normally received. Since the processing apparatus does not receive the signal emitted from the first sensor, the processing apparatus controls the moving assembly to stop moving toward the first sidewall. That is, the moving assembly does not strike against the first sidewall. When the moving assembly moves to the position directly in front of the second sensor, the second sensor is blocked, so that a signal emitted from the second sensor is not normally received. Since the processing apparatus does not receive the signal emitted from the second sensor, the processing apparatus controls the moving assembly to stop moving toward the second sidewall. That is, the moving assembly does not strike against the second sidewall.

Therefore, compared with the prior art, the processing apparatus of the present disclosure does not strike against the first and second sidewalls of the housing during operation, which avoids generation of striking noise, improves user experience, avoids component wear and tear caused by striking against the first and second sidewalls, and increases the service life of the processing apparatus. Meanwhile, due to configurations of the first sensor and the second sensor, the moving assembly no longer needs to strike against the first sidewall or the second sidewall for positioning, but instead utilizes the first sensor and the second sensor as anchor points for positioning. Compared with the prior art, the moving assembly of the present disclosure omits unnecessary travel between the first sensor and the first sidewall as well as unnecessary travel between the second sensor and the second sidewall, thereby increasing a proportion of an effective working travel of the moving assembly of the present disclosure and improving movement accuracy of the moving assembly. Meanwhile, omissions of the unnecessary travels for striking against the first and second sidewalls further greatly improves the processing efficiency of the processing apparatus. Under the same workload, the processing apparatus of the present disclosure completes work faster.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a processing apparatus according to one embodiment of the present disclosure.

FIG. 2 is another schematic diagram of the processing apparatus according to one embodiment of the present disclosure.

FIG. 3 is an exploded schematic diagram of the processing apparatus according to one embodiment of the present disclosure.

FIG. 4 is a schematic diagram of a worktable of the processing apparatus according to one embodiment of the present disclosure.

FIG. 5 is an exploded schematic diagram of the processing apparatus according to one embodiment of the present disclosure, where the worktable and a housing are removed.

FIG. 6 is another exploded schematic diagram of the processing apparatus according to one embodiment of the present disclosure, where the worktable and a housing are removed.

FIG. 7 is a schematic diagram of a driving component of a processing apparatus according to one embodiment of the present disclosure.

FIG. 8 is an exploded schematic diagram of the driving component shown in FIG. 7.

FIG. 9 is a schematic diagram of a driving roller of the driving component shown in FIG. 7.

FIG. 10 is a schematic diagram of a rod portion of the driving component shown in FIG. 7.

FIG. 11 is a schematic diagram of an elastic member of the driving component shown in FIG. 7.

FIG. 12 is another schematic diagram of the elastic member of the driving component according to one embodiment of the present disclosure.

FIG. 13 is a schematic diagram of the driving component and a second gear according to one embodiment of the present disclosure.

FIG. 14 is a schematic diagram of a first configuration of the driving component according to one embodiment of the present disclosure.

FIG. 15 is a schematic diagram of a second configuration of the driving component according to one embodiment of the present disclosure.

FIG. 16 is an exploded schematic diagram of a third configuration of the driving component according to one embodiment of the present disclosure.

FIG. 17 is a partial exploded schematic diagram of a mounting member and a guiding assembly in FIG. 16.

FIG. 18 is a schematic diagram of a housing structure of the processing apparatus according to one embodiment of the present disclosure.

FIG. 19 is an exploded schematic diagram of the housing structure shown in FIG. 18.

FIG. 20 is a schematic diagram of a fourth configuration of the driving component according to one embodiment of the present disclosure.

FIG. 21 is another schematic diagram of the processing apparatus according to one embodiment of the present disclosure.

FIG. 22 is a partial schematic diagram of the processing apparatus shown in FIG. 21.

FIG. 23 is another partial schematic diagram of the processing apparatus shown in FIG. 21.

FIG. 24 is another partial schematic diagram of the processing apparatus shown in FIG. 21.

FIG. 25 is a schematic diagram of a torsion component and a torsion spring according to one embodiment of the present disclosure.

FIG. 26 is a perspective schematic diagram of the torsion component according to one embodiment of the present disclosure.

FIG. 27 is a cross-sectional schematic diagram of the torsion component shown in FIG. 26.

FIG. 28 is an exploded schematic diagram of the torsion component according to one embodiment of the present disclosure.

FIG. 29 is a schematic diagram of the torsion component according to one embodiment of the present disclosure, where a first limiting portion and a sleeving portion are integrally provided.

FIG. 30 is another schematic diagram of the torsion component according to one embodiment of the present disclosure from another angle, where the first limiting portion and the sleeving portion are integrally provided.

FIG. 31 is a schematic diagram of a second limiting portion in the torsion component according to one embodiment of the present disclosure.

FIG. 32 is an enlarged view of a portion A shown in FIG. 31.

FIG. 33 is another schematic diagram of the second limiting portion of the torsion component according to one embodiment of the present disclosure from another angle.

FIG. 34 is a schematic diagram of a belt tensioning mechanism according to one embodiment of the present disclosure.

FIG. 35 is another schematic diagram of the belt tensioning mechanism according to one embodiment of the present disclosure.

FIG. 36 is a side view of the belt tensioning mechanism according to one embodiment of the present disclosure.

FIG. 37 is an exploded schematic diagram of the belt tensioning mechanism according to one embodiment of the present disclosure.

FIG. 38 is a schematic diagram of a belt drive mechanism according to one embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

Reference herein to “embodiment” means that a particular feature, structure, or characteristic described in connection with one embodiment may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

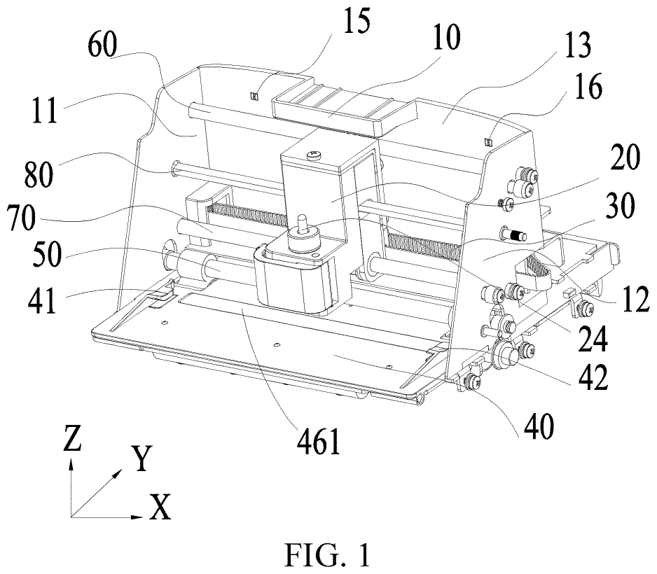

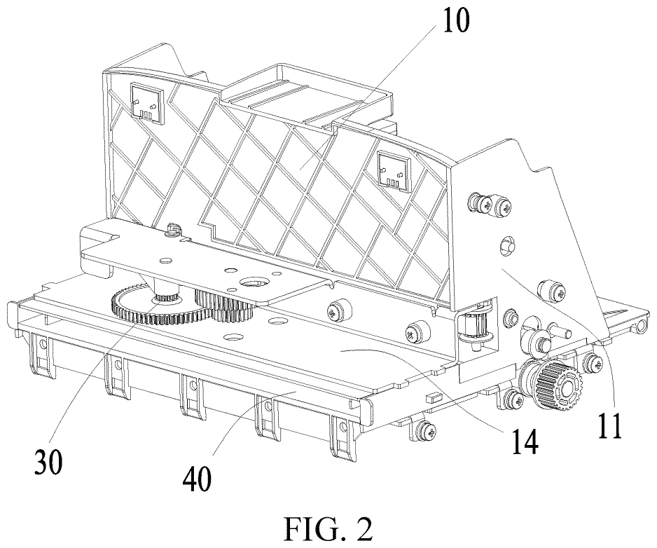

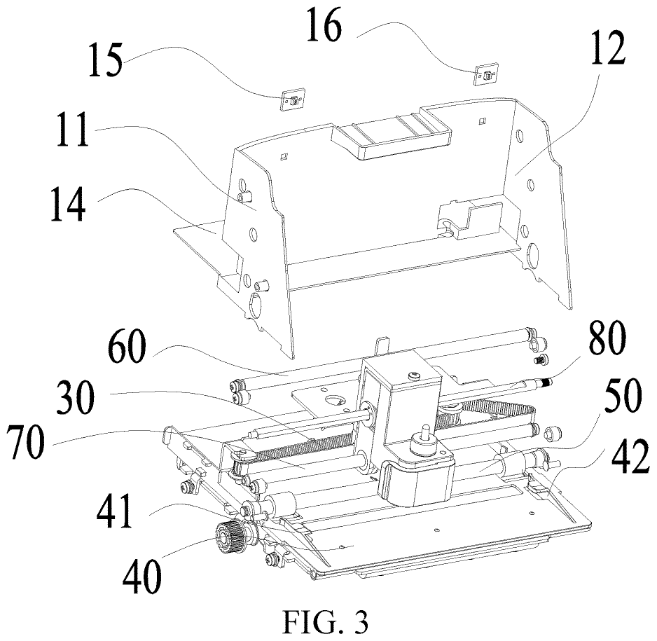

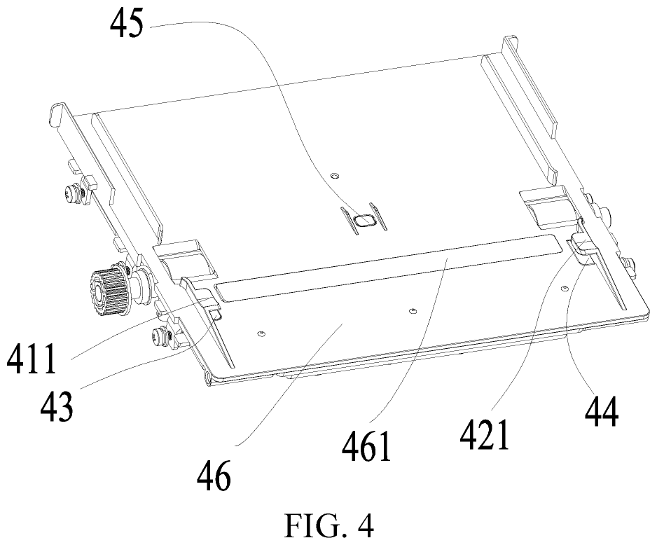

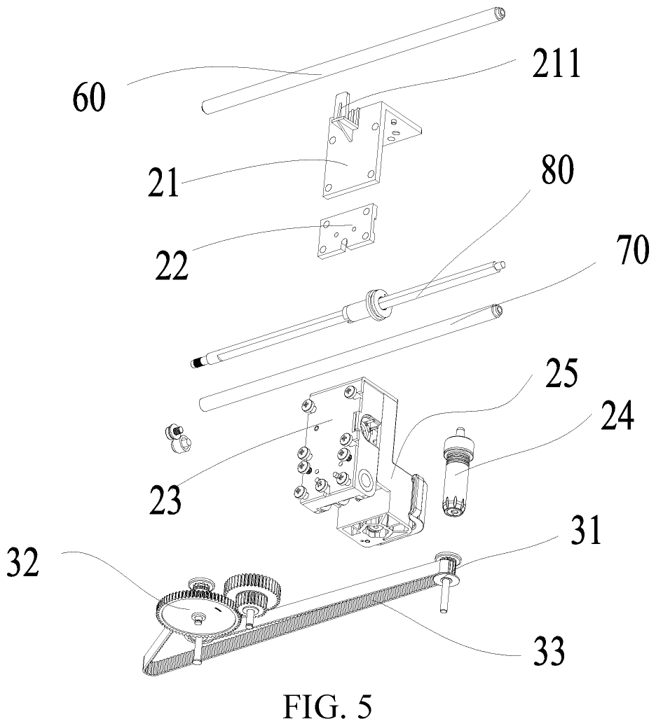

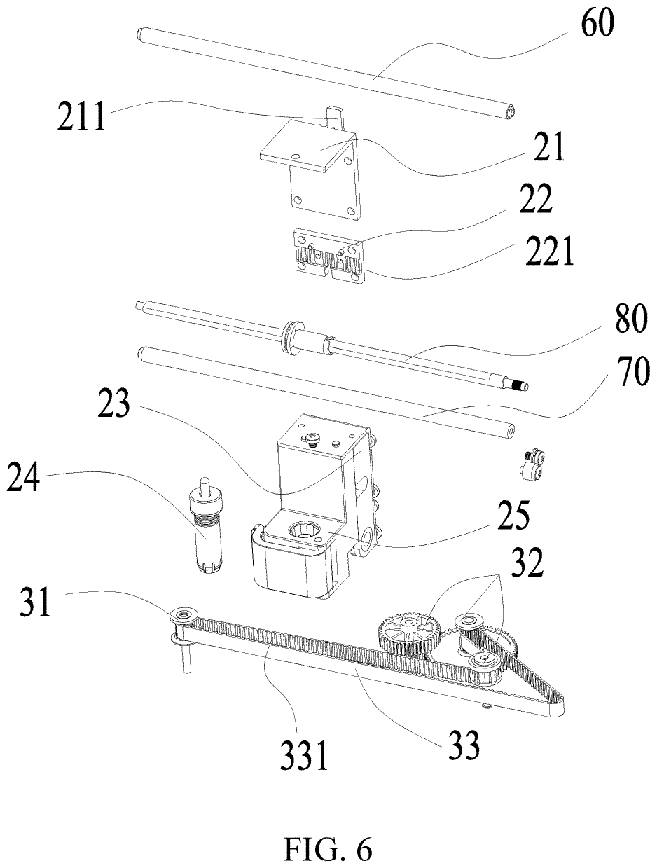

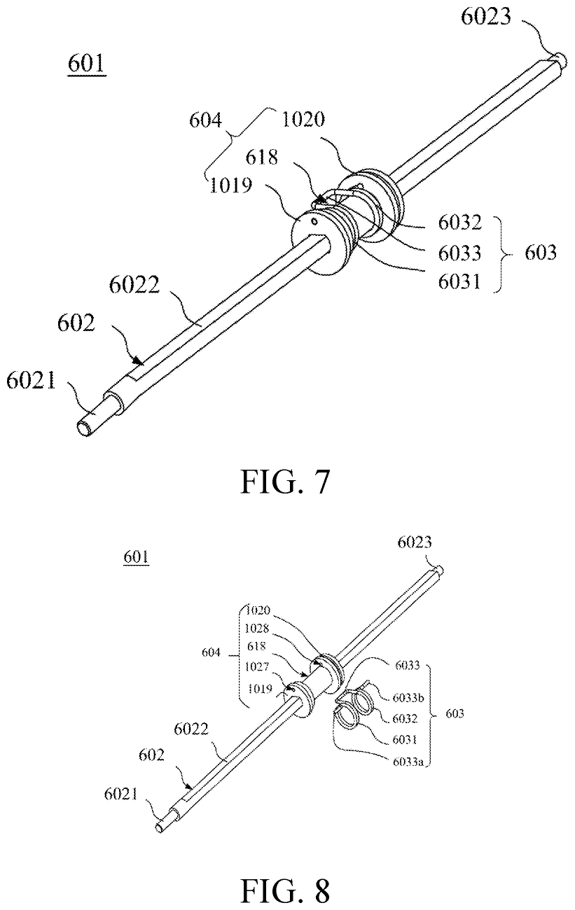

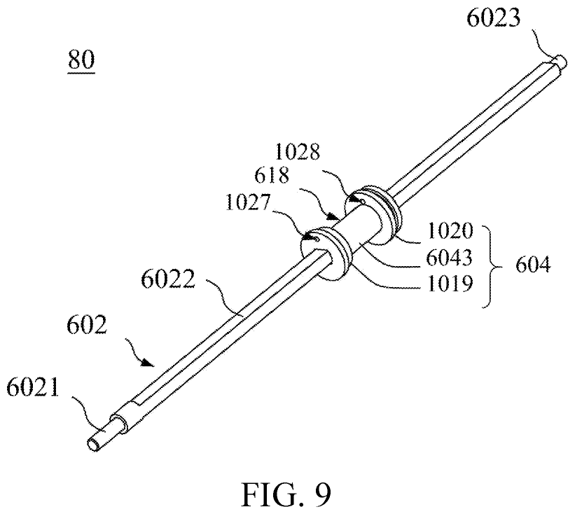

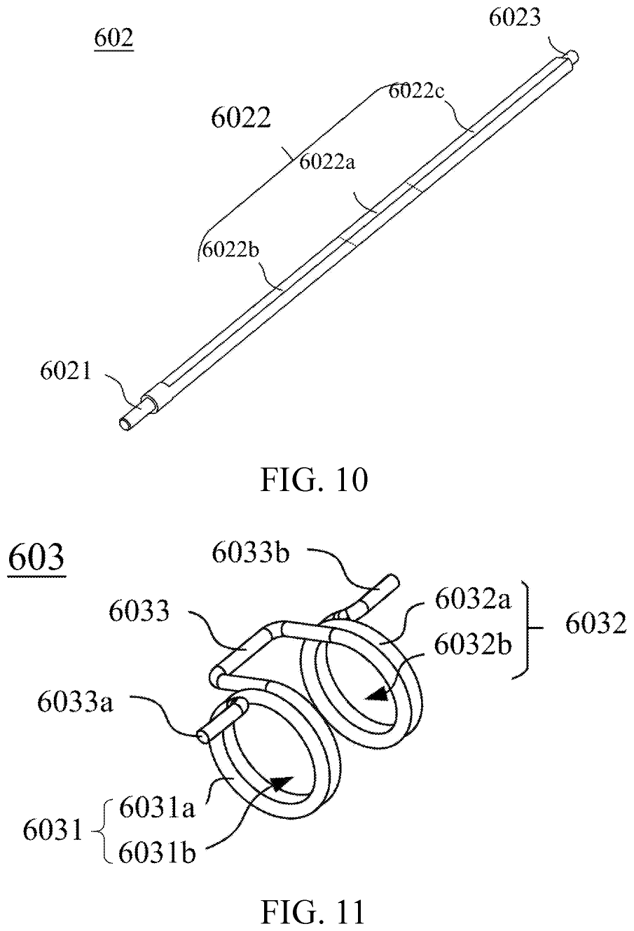

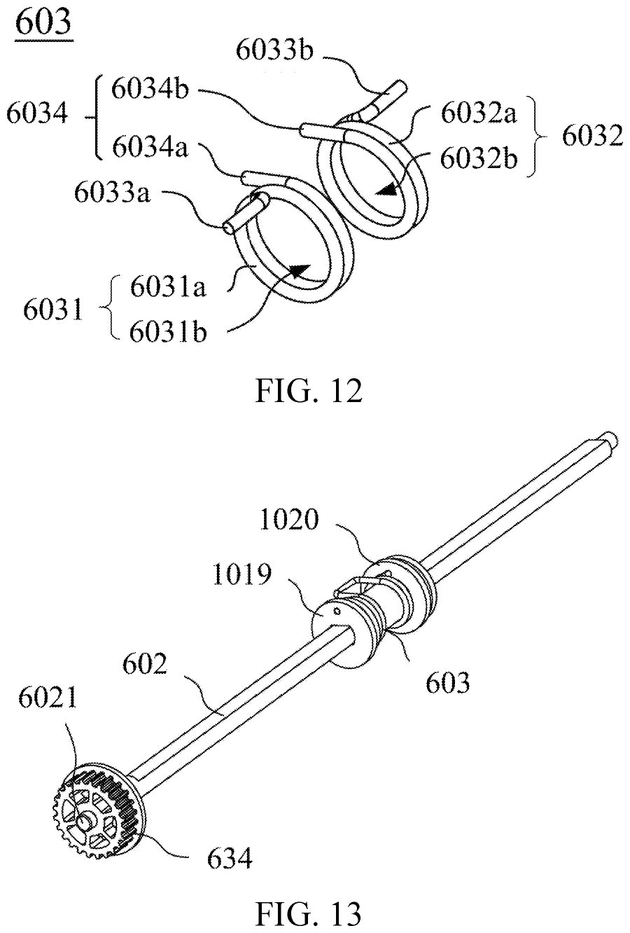

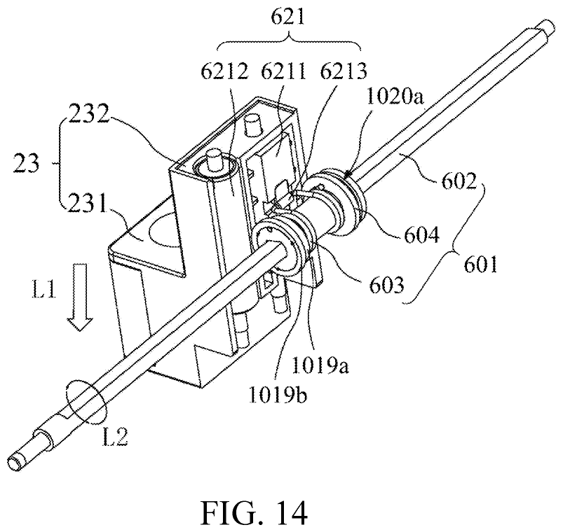

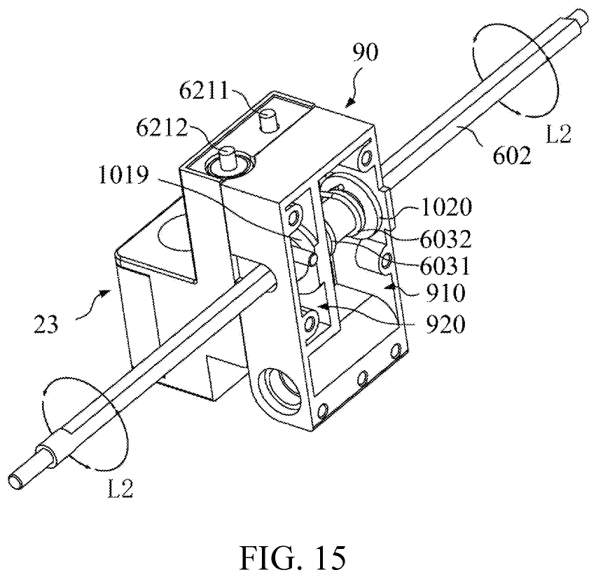

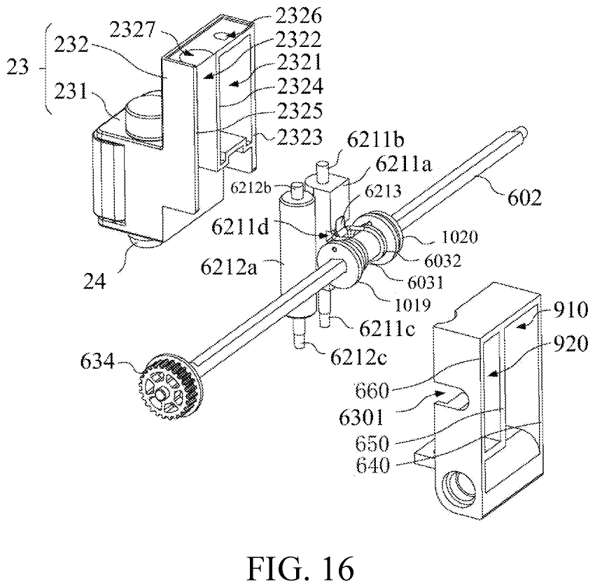

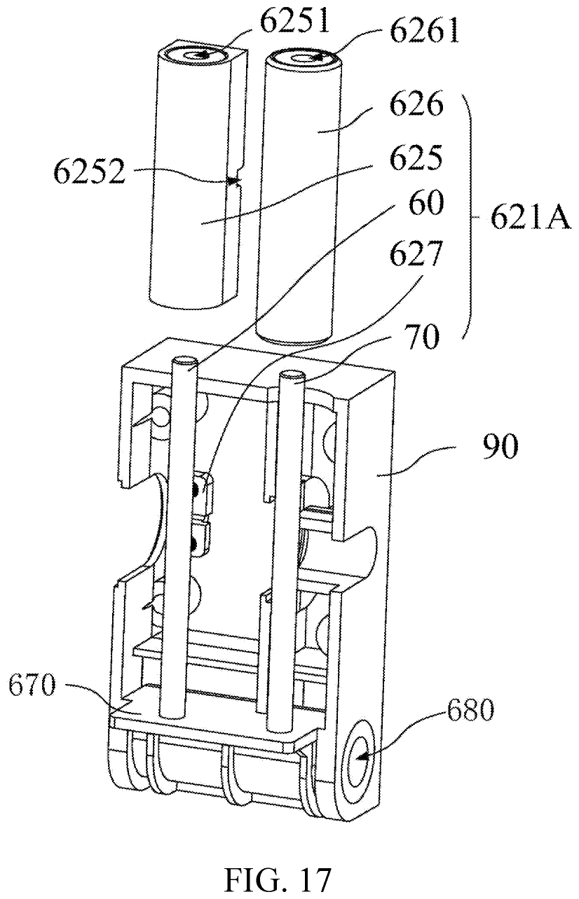

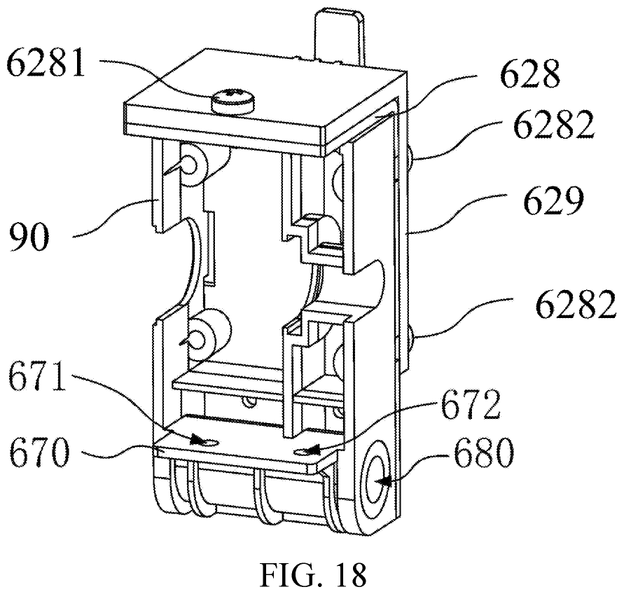

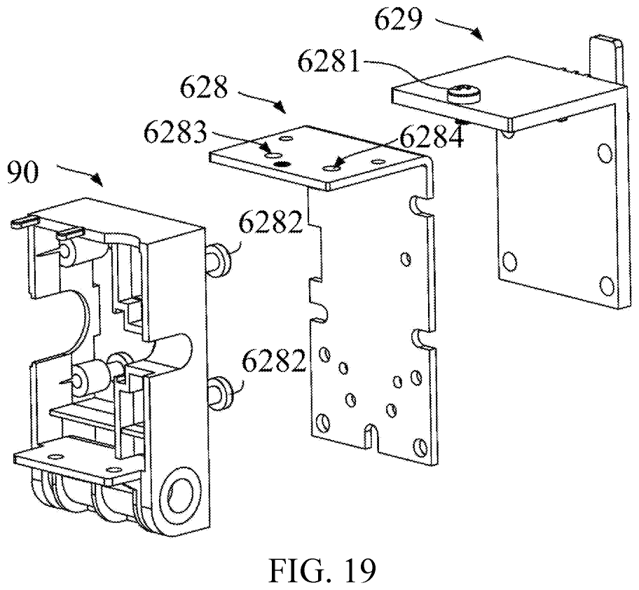

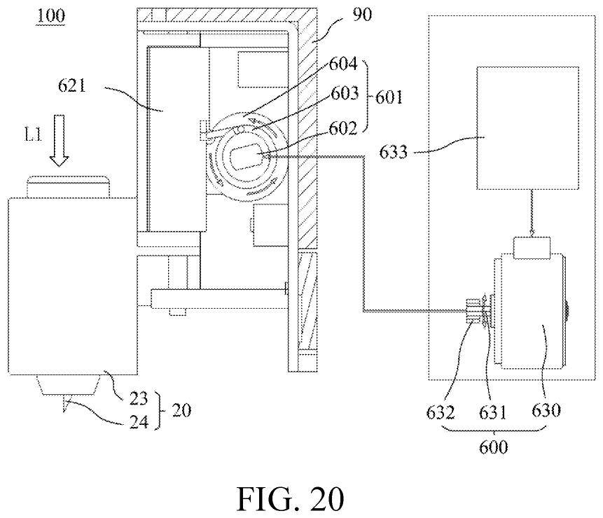

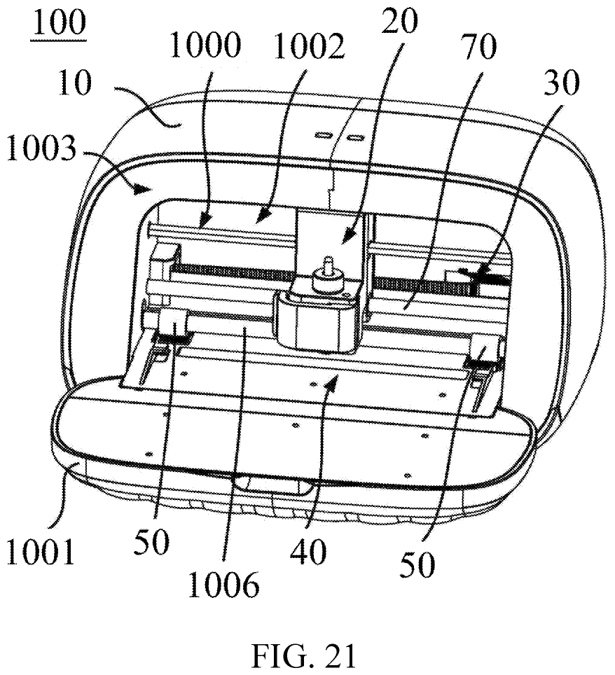

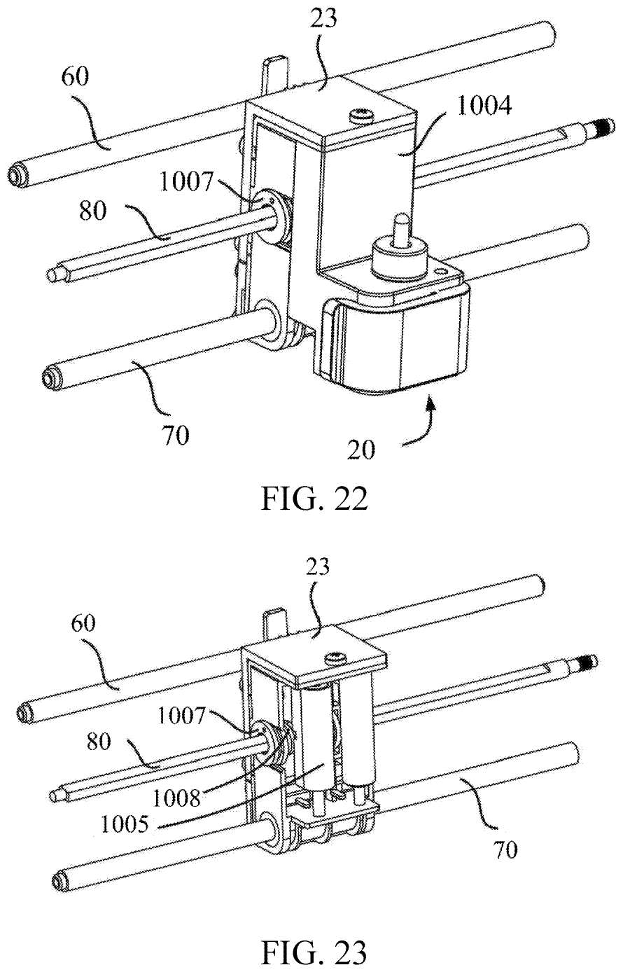

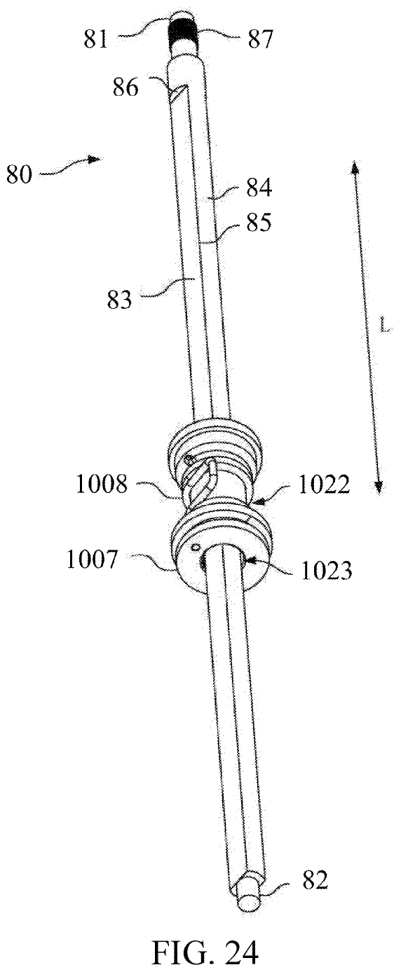

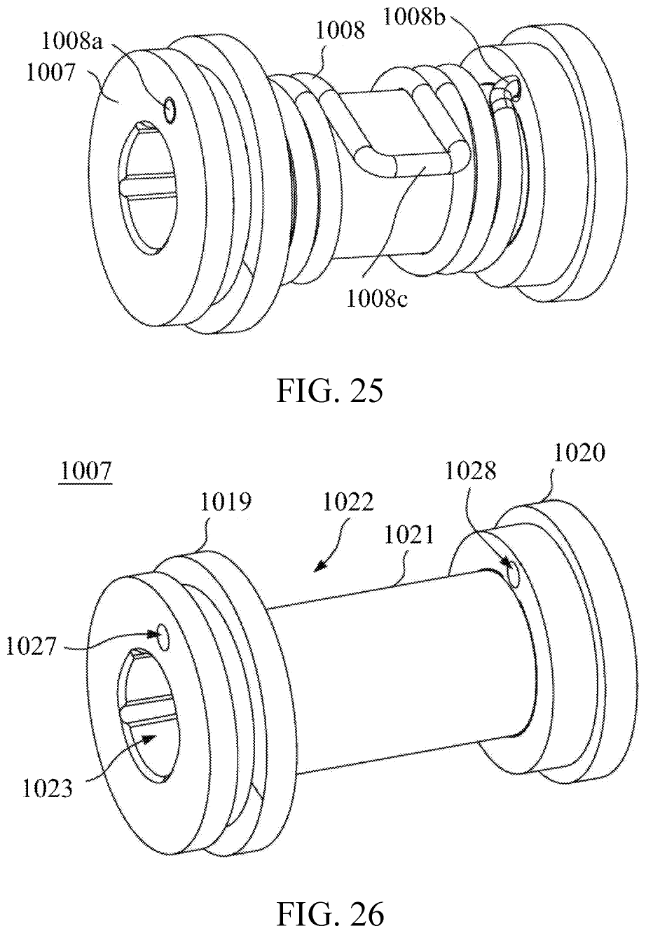

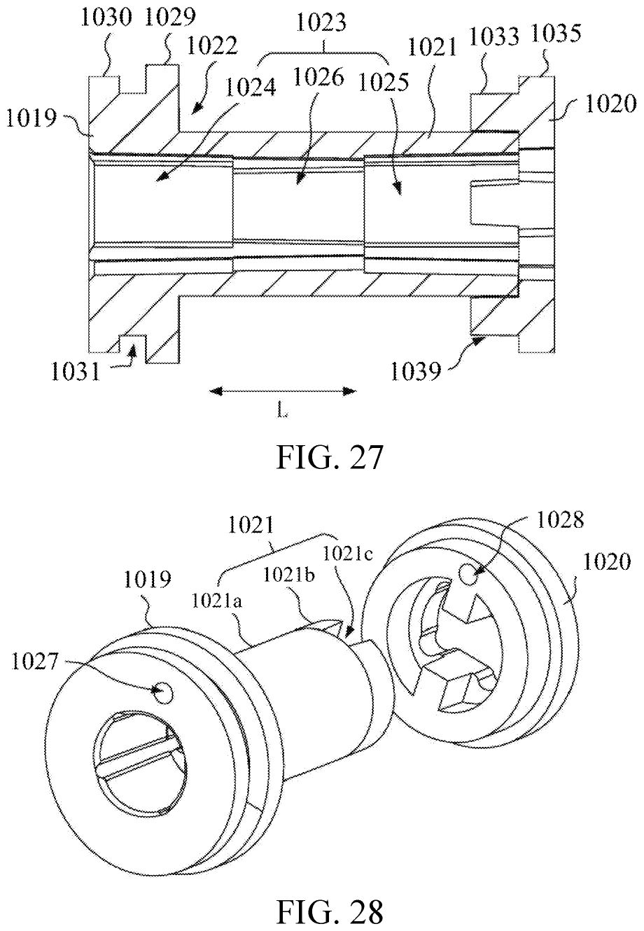

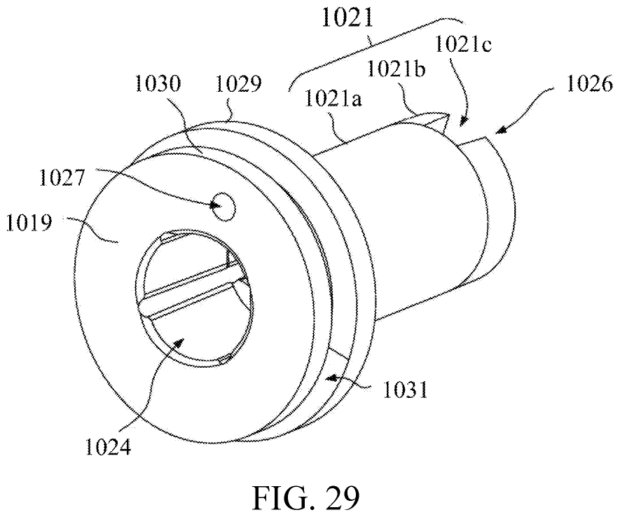

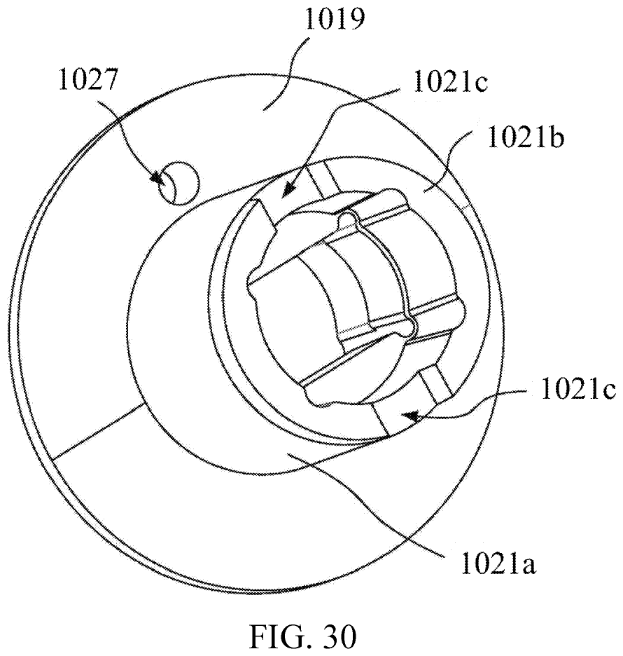

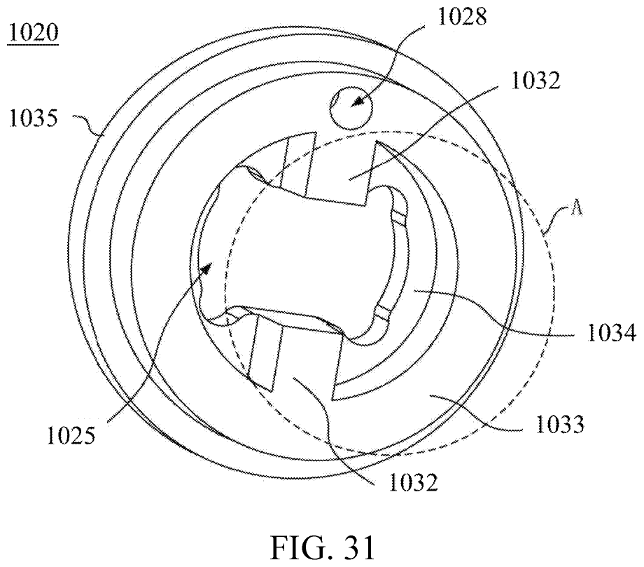

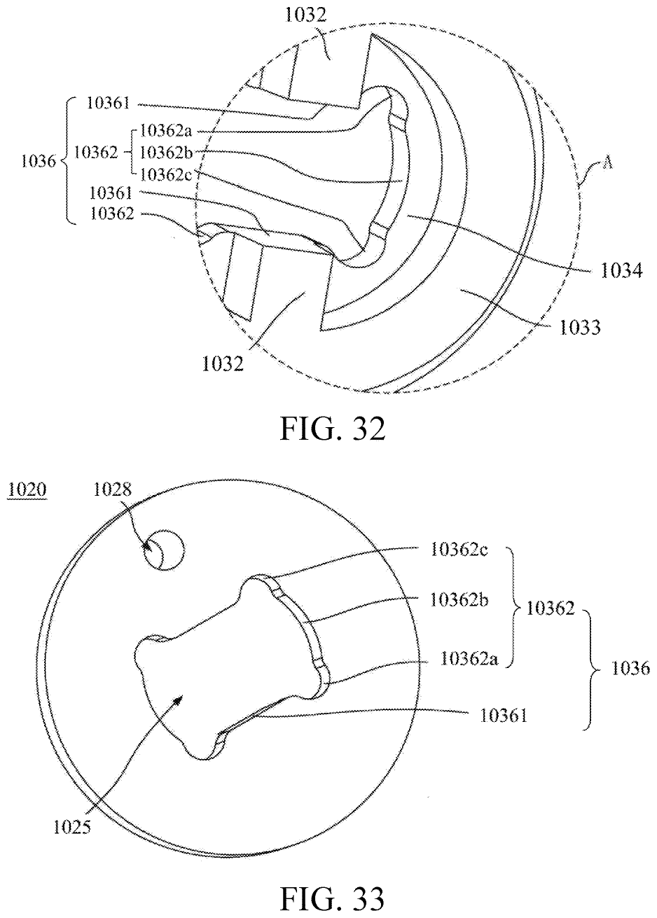

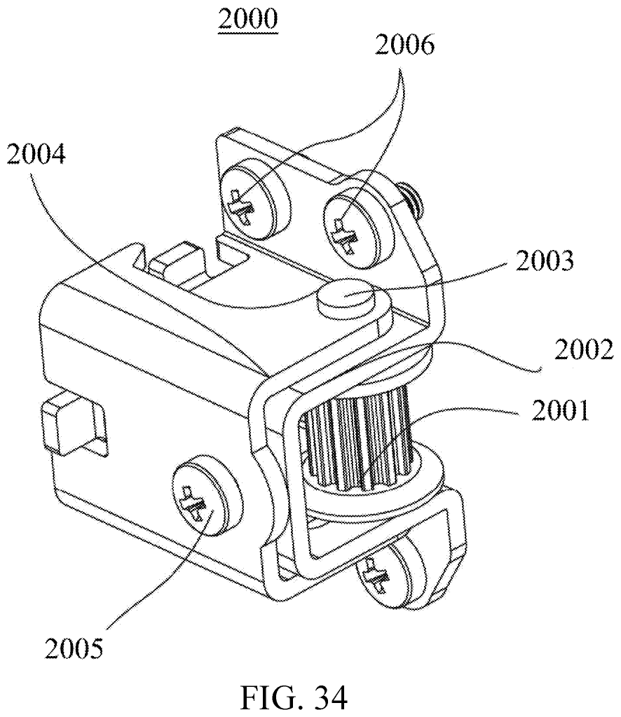

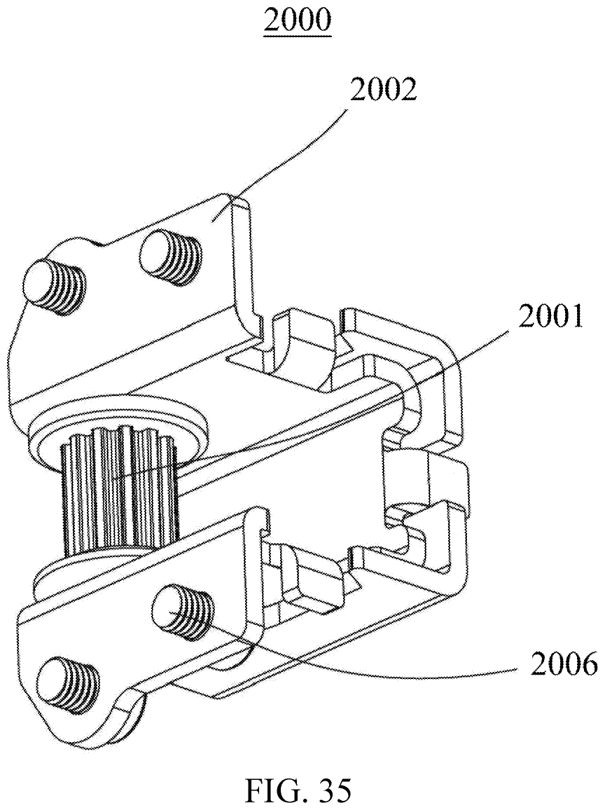

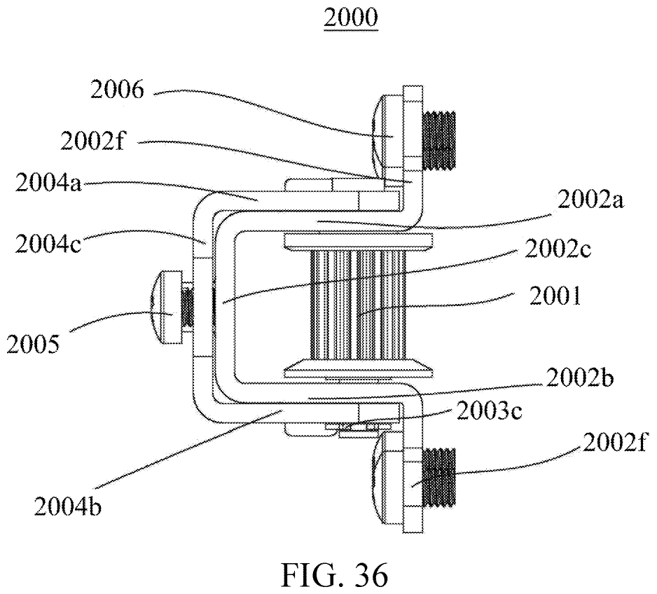

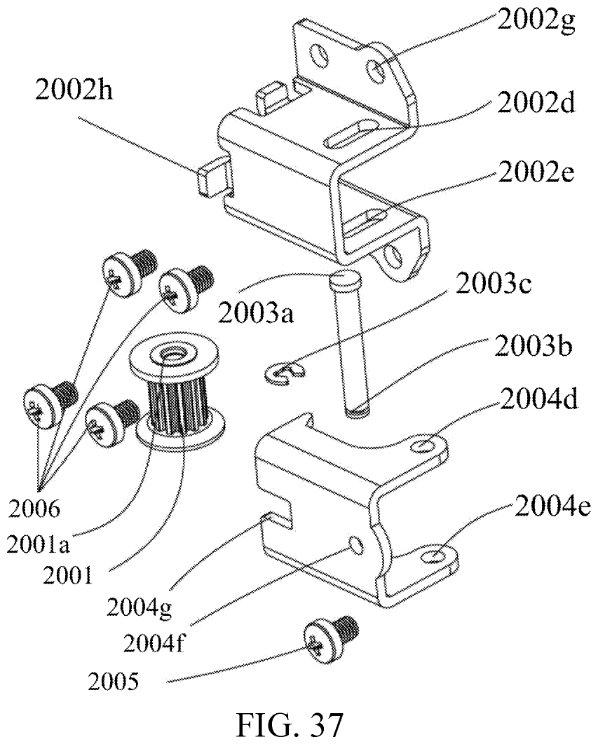

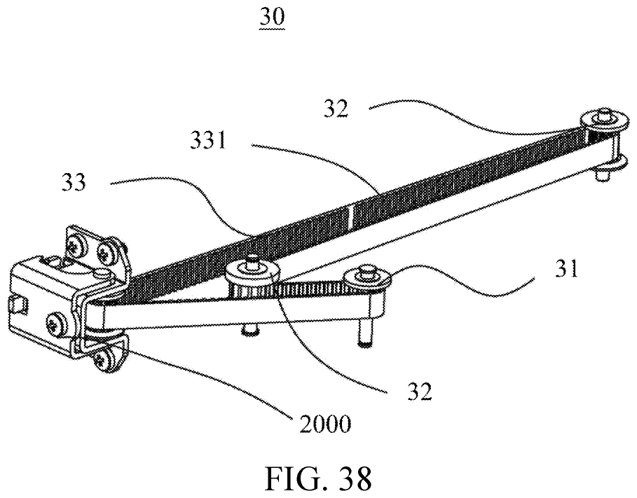

As shown in FIGS. 1-6, the present disclosure provides a processing apparatus featuring anti-striking walls, low noise, precise workpiece positioning, and high processing efficiency. The processing apparatus 100 comprises: a housing 10, a first sensor 15, a second sensor 16, a transmission assembly 30, and a moving assembly 20.

The housing 10 comprises a first sidewall 11, a second sidewall 12, and a third sidewall 13. The first sidewall 11 and the second sidewall 12 are disposed opposite to each other. The third sidewall 13 connects the first sidewall 11 and the second sidewall 12. The first sensor 15 and the second sensor 16 are disposed on the third sidewall 13, and the first sensor 15 is adjacent to the first sidewall 11. The second sensor 16 is adjacent to the second sidewall 12. The transmission assembly 30 is drivingly connected to the moving assembly 20, and the transmission assembly 30 is configured to drive the moving assembly 20 to move between the first sidewall 11 and the second sidewall 12.

When the moving assembly 20 moves to a position directly in front of the first sensor 15 the first sensor 15 is blocked, and the processing apparatus 100 controls the moving assembly 20 to stop moving toward the first sidewall 11. When the moving assembly 20 moves to a position directly in front of the second sensor 16, the second sensor 16 is blocked, and the processing apparatus 100 controls the moving assembly 20 to stop moving toward the second sidewall 12.

The first sensor 15 and the second sensor 16 may be transmissive photoelectric sensors diffuse-reflective photoelectric sensors, or through-beam photoelectric sensors. In the embodiment, description is made by taking an example in which the first sensor 15 and the second sensor 16 are the diffuse-reflective photoelectric sensors.

The processing apparatus of the present disclosure introduces the first sensor 15 and the second sensor 16. When the moving assembly 20 moves to the position directly in front of the first sensor 15, the first sensor 15 is blocked, so that a signal from the first sensor 15 is not normally received. Since the processing apparatus 100 does not receive the signal emitted from the first sensor 15, the processing apparatus 100 controls the moving assembly 20 to stop moving toward the first sidewall 11. That is, the moving assembly 20 does not strike against the first sidewall 11. When the moving assembly 20 moves to the position directly in front of the second sensor 16, the second sensor 16 is blocked, so that a signal emitted from the second sensor 16 is not normally received. Since the processing apparatus 100 does not receive the signal emitted from the second sensor 16, the processing apparatus 100 controls the moving assembly 20 to stop moving toward the second sidewall 12. That is, the moving assembly 20 does not strike against the second sidewall 12. Therefore, compared with the prior art, the processing apparatus 100 of the present disclosure does not strike against the first and second sidewalls of the housing 10 during operation, which avoids generation of striking noise, improves user experience, avoids component wear and tear caused by striking against the first and second sidewalls, and increases a service life of the processing apparatus 100.

Meanwhile, due to the configurations of the first sensor 15 and the second sensor 16, the moving assembly 20 no longer needs to strike against the first sidewall 11 or the second sidewall 12 for positioning, but instead utilizes the first sensor 15 and the second sensor 16 as anchor points for positioning. Therefore, the first sensor 15 and the second sensor 16 are configured as edge-finding sensors. For example, during each startup or shutdown, the moving assembly 20 may move to the position directly in front of the first sensor 15 or the position directly in front of the second sensor 16 to define the position as a zero point of the moving assembly 20.

In addition, compared with the prior art, the moving assembly 20 of the present disclosure omits unnecessary travel between the first sensor 15 and the first sidewall 11 as well as unnecessary travel between the second sensor 16 and the second sidewall 12, thereby increasing a proportion of an effective working travel of the moving assembly 20 of the present disclosure and improving movement accuracy of the moving assembly 20. Meanwhile, omissions of the unnecessary travels for striking against the first and second sidewalls further greatly improves the processing efficiency of the processing apparatus 100. Under the same workload, the processing apparatus 100 of the present disclosure completes work faster.

In the embodiment, when the moving assembly 20 moves to the position directly in front of the first sensor 15, the first sensor 15 is blocked, and after the processing apparatus 100 controls the moving assembly 20 to stop moving toward the first sidewall 11, the processing apparatus 100 controls the moving assembly 20 to stop or controls the moving assembly 20 to move toward the second sidewall 12. When the moving assembly 20 moves to the position directly in front of the second sensor 16, the second sensor 16 is blocked, and after the processing apparatus 100 controls the moving assembly 20 to stop moving toward the second sidewall 12, the processing apparatus 100 controls the moving assembly 20 to stop or controls the moving assembly 20 to move toward the first sidewall 11.

In one optional embodiment, the processing apparatus 100 further comprises a worktable 40. The housing 10 is connected to the worktable 40. The transmission assembly 30 is disposed on the worktable 40 and is movably connected to the housing 10 and the worktable 40. Specifically, the housing 10 further comprises a bottom wall 14. The bottom wall 14 is connected to the first sidewall 11, the second sidewall 12, and the third sidewall 13. Therefore, the processing apparatus 100 is a structurally stable unit.

A first limiting portion 41 and a second limiting portion 42 are disposed on the worktable 40. The first limiting portion 41 and the second limiting portion 42 are opposite to each other to define a working area 46 of the worktable 40. The first limiting portion 41 comprises a first limiting plate 411, and the second limiting portion 42 comprises a second limiting plate 421. The first limiting plate 411 is disposed on one side of the first limiting portion 41 and extends toward the second limiting portion 42. The second limiting plate 421 is disposed on one side of the second limiting portion 42 and extends toward the first limiting portion 41. It should be noted that the processing apparatus 100 of the embodiment may be applied to a cutting plotter for processing workpieces with relatively small thicknesses, such as paper, adhesive stickers, car stickers, wall stickers, instant stickers, etc. The working area 46 refers to a processing area 461 after a workpiece is placed onto the worktable 40. The first limiting portion 41 and the second limiting portion 42 are respectively disposed on a left side and a right side of the worktable 40 to limit a width of the external workpiece placed into the processing apparatus 100.

In one optional embodiment, a predetermined distance is defined between the working area 46 and each of the first limiting plate 411 and the second limiting plate 421 to limit a thickness of the external workpiece entering the working area 46. During processing, upon confirming that the width of the external workpiece conforms to a width limited by the first limiting portion 41 and the second limiting portion 42, the external workpiece is first placed into the working area 46 of the worktable 40. Thereafter, the external workpiece needs to be placed in a space defined by the first limiting plate 411, the second limiting plate 421, and the working area 46. On the one hand, such a configuration limits the thickness of the external workpiece to be processed. If the thickness of the external workpiece is relatively large and exceeds a vertical distance between the first limiting plate 411 and the working area 46, the moving assembly may fail to complete cutting of the external workpiece in subsequent processing. On the other hand, the first limiting plate 411 and the second limiting plate 421 are further configured to press down the external workpiece, thereby preventing the external workpiece from warping and affecting subsequent processing operations.

In one optional embodiment, the processing apparatus 100 further comprises a third sensor 43, a fourth sensor 44, and a conveying roller 50. The third sensor 43, the fourth sensor 44, and the conveying roller 50 are disposed on the worktable 40. The third sensor 43 is located directly below the first limiting plate 411. The fourth sensor 44 is located directly below the second limiting plate 421. The conveying roller 50 is disposed adjacent to the working area 46. When the external workpiece enters the working area 46 and blocks the third sensor 43 and the fourth sensor 44, the conveying roller 50 rotates in a forward direction to draw in the external workpiece and drive the external workpiece to move. Two ends of the conveying roller 50 are respectively movably connected to the first sidewall 11 and the second sidewall 12. A fifth sensor 45 is further disposed on the working area 46, and the fifth sensor 45 is close to an inner side of the working area 46.

In the embodiment, the third sensor 43, the fourth sensor 44, and the fifth sensor 45 may also be transmissive photoelectric sensors, diffuse-reflective photoelectric sensors, or through-beam photoelectric sensors. Specifically, description is likewise made by taking an example in which the third sensor 43, the fourth sensor 44, and the fifth sensor 45 are the diffuse-reflective photoelectric sensors.

The processing apparatus 100 has a pre-working state and a working state, and is switchable between the pre-working state and the working state. The pre-working state refers to a state in which the external workpiece is fed into the working area 46, and the moving assembly 20 has not yet begun to process the external workpiece. Therefore, in the pre-working state, the moving assembly 20 does not operate, and the moving assembly 20 is disposed at a predetermined working zero point by utilizing the first sensor 15 or the second sensor 16 as a reference point (such as the position directly in front of the first sensor 15, the position directly in front of the second sensor 16, or a midpoint between the first sensor 15 and the second sensor 16, which is specifically determined according to requirements).

When the processing apparatus 100 is in the pre-working state, the moving assembly 20 remains stationary, and a user is able to place the external workpiece onto the worktable 40. Since the third sensor 43 and the fourth sensor 44 are respectively located directly below the first limiting plate 411 and the second limiting plate 421, when the external workpiece is correctly placed, the third sensor 43 and the fourth sensor 44 are blocked, resulting in a change in luminous flux. The processing apparatus 100 is capable of recognizing the change in luminous flux fed back by the third sensor 43 and the fourth sensor 44, and controls the conveying roller 50 to rotate. The conveying roller rotates to draw in and convey the external workpiece. In the embodiment, the third sensor 43, the fourth sensor 44, and the fifth sensor 45 also serve as edge finders. The third sensor 43 or the fourth sensor 44 serve as an anchor point to determine a midpoint of the external workpiece in a width direction, and the fifth sensor 45 is then configured as an anchor point to determine a zero point of the external workpiece in a length direction, thereby determining a processing center of the external workpiece.

It should be noted that in the present disclosure, the aforementioned situation where the width and the thickness of the external workpiece are not allowed to exceed predetermined ranges is defined as a precondition for placing the external workpiece, and the external workpiece is only allowed to be placed when the precondition for placing the external workpiece is satisfied. Therefore, a definition of the external workpiece being incorrectly placed herein refers to a situation of misoperation under a condition that the precondition for placement is satisfied. For example, if the external workpiece is accidentally placed above the first limiting plate 411 and the second limiting plate 421 during placement, the third sensor 43 and the fourth sensor 44 are not blocked at this time. Therefore, the processing apparatus 100 does not control the conveying roller 50 to rotate, and the external workpiece is not drawn in. When the user finds that the external workpiece is not drawn in, it is determined that the placement of the external workpiece is abnormal. As another example, when the user places the external workpiece with a width significantly less than that of the working area 46, the external workpiece is unable to effectively block both the third sensor 43 and the fourth sensor 44, and the external workpiece is also not drawn in for subsequent processing. The configurations of the third sensor 43 and the fourth sensor 44 further ensure processing safety and prevent the occurrence of processing abnormalities.

After the external workpiece is drawn in by the conveying roller 50, it is necessary to determine when processing of the external workpiece can begin. That is, it is necessary to determine at what moment the processing apparatus 100 switches from the pre-working state to the working state. To solve this problem, the present disclosure introduces the fifth sensor 45. In the pre-working state, when the conveying roller 50 rotates in the forward direction, the external workpiece is driven to move toward the inner side of the working area 46. The fifth sensor 45 is located on the inner side of the working area 46. When the external workpiece is further conveyed to the inner side of the working area 46 and blocks the fifth sensor 45, the luminous flux emitted from the fifth sensor 45 changes. The processing apparatus 100 receives luminous flux information fed back from the fifth sensor 45 and controls the conveying roller to stop rotating. At this point, the pre-working state ends. When the fifth sensor 45 is blocked for a predetermined time, the processing apparatus 100 switches from the pre-working state to the working state, the conveying roller 50 is switchable among three states of forward rotation, reverse rotation, and non-rotation, and the moving assembly 20 moves between the first sidewall 11 and the second sidewall 12 to process the external workpiece.

It should be noted that after entering the working state, the conveying roller 50 does not remain stationary but selectively rotates according to processing requirements of the external workpiece. In the working state, the conveying roller 50 has three operating states. Specifically, the conveying roller 50 may rotate in the forward direction to further draw in the external workpiece, thereby facilitating processing of different areas of the external workpiece by the moving assembly 20. The conveying roller 50 may rotate in a reverse direction to discharge the external workpiece, thereby facilitating removal of the processed workpiece, or facilitating the external workpiece to be drawn in again for a subsequent processing operation. The conveying roller 50 may also not rotate. At this time, the conveying roller 50 is configured as a fixing device, which cooperates with the first limiting plate 411 and the second limiting plate 421 to further fix the external workpiece, maintain the external workpiece in a tensioned state, and prevent movement of the external workpiece, thereby facilitating processing of the external workpiece by the moving assembly 20. Thus, it is noted that when the processing apparatus 100 is in the working state, the moving assembly 20 does not remain in motion during the entire process.

In one optional embodiment, the processing apparatus 100 further comprises a first guide rod 60, a driving roller 80, and a second guide rod 70. The first guide rod 60, the driving roller 80, and the second guide rod 70 are parallel to each other and are disposed from top to bottom. Two ends of the first guide rod 60 are respectively connected to the first sidewall 11 and the second sidewall 12. Two ends of the second guide rod 70 are respectively connected to the first sidewall 11 and the second sidewall 12. Two ends of the driving roller 80 are respectively rotatably connected to the first sidewall 11 and the second sidewall 12. The moving assembly 20 is movably connected to the first guide rod 60 and the second guide rod 70. The first guide rod 60 is located at a rear side of the moving assembly 20. The moving assembly 20 is movable along the first guide rod 60, the driving roller 80, and the second guide rod 70. In the embodiment, the first guide rod 60 and the second guide rod 70 may be fixedly connected to the housing 10 through fasteners, such as screws. That is, the first guide rod 60 and the second guide rod 70 are non-rotatable. The driving roller 80 is movably connected to the housing 10. That is, the driving roller 80 is rotatable. The first guide rod 60, the driving roller 80, and the second guide rod 70 are configured to limit and guide the moving assembly 20. Since the first guide rod 60, the driving roller 80, and the second guide rod 70 are parallel to each other between the first sidewall 11 and the second sidewall 12, the moving assembly 20 is capable of performing a horizontal movement between the first sidewall 11 and the second sidewall 12.

In one optional embodiment, the moving assembly 20 comprises a moving piece 23, tool 24, and a mounting base 25. The driving roller 80 and the second guide rod 70 pass through the moving piece 23. The driving roller 80 passes through a middle portion of the moving piece 23, and the second guide rod 70 passes through a lower portion of the moving piece 23. Therefore, the moving piece 23 is stably secured and is less prone to shaking. The mounting base is movably connected to the moving piece 23, and the tool 24 is movably clamped within the mounting base 25. The tool 24 is configured to mount workpiece processing instruments of different specifications, such as a blade (not shown) for processing the external workpiece on the working area 46, or the tool itself is a workpiece processing instrument, such as a pen, a syringe, a drawing stick, etc. The driving roller 80 is configured to rotate to drive the mounting base 25 to move up and down, thereby causing the tool 24 to move up and down, so as to control a processing depth of the tool 24 on the external workpiece. During a movement of the moving assembly 20, an orthographic projection of the tool 24 always falls within the working area 46. That is, a movement range of the tool 24 does not exceed the working area 46. Specifically, during the movement of the moving assembly 20 along the second guide rod 70 and the driving roller 80, due to the configurations of the first sensor 15 and the second sensor 16, a maximum horizontal movement travel is defined for the tool 24 of the moving assembly 20. The maximum horizontal movement travel of the tool 24 is always within the working area 46, which means that the moving assembly 20 has higher processing accuracy. Meanwhile, since the working area 46 is defined by the first limiting portion 41 and the second limiting portion 42, the tool 24 does not hit the first limiting portion 41 and the second limiting portion 42 on the worktable 40 during horizontal movement within the working area 46, thereby improving operational safety.

In one optional embodiment, the working area 46 further comprises a processing area 461. The orthographic projection of the tool 24 always falls within the processing area 461. In the embodiment, description is made by taking an example in which a blade is mounted on the tool 24. The processing area 461 may be a groove. Since the tool 24 is sleeved in the moving piece 23, the maximum horizontal movement travel is also defined for the blade. A width of the processing area 461 is not less than the maximum horizontal movement travel of the blade. That is, the processing area 461 is corresponding to a movement travel of the blade. Since the blade moves up and down to control the processing depth of the external workpiece, and the blade is relatively sharp, when the external workpiece is completely cut through, the blade inevitably contacts the processing area 461. If the processing area 461 is not protected, the service life of both the worktable 40 and the blade is affected. Therefore, in the embodiment, the processing area 461 is configured as the groove, which defines a larger cutting space for the blade and prevents the blade from contacting a groove bottom of the groove, thereby extending the service life of the worktable 40 and the blade. Alternatively, in other embodiments, a flexible material, such as silicone or rubber, may be laid at a groove bottom of the processing area 461, so that even if the blade contacts a bottom portion of the processing area 461, the blade is not damaged, which extends the service life of the worktable 40 and the blade.

In one optional embodiment, the moving piece 23 further comprises a first mounting plate 21. The first mounting plate 21 is stacked on the moving piece 23. An L-shaped baffle 211 is disposed at an upper portion of an outer side of the first mounting plate 21. The L-shaped baffle 211 is connected to the first mounting plate 21 to define a limiting space, and a portion of the first guide rod 60 is clamped within the limiting space. Since the blade on the tool 24 may vibrate during processing, and a vibration of the blade may be transmitted to the moving piece 23 to cause the moving piece 23 to vibrate up and down. To solve this problem, the first guide rod 60 and the L-shaped baffle 211 cooperating with the first guide rod 60 are provided. Since the portion of the first guide rod 60 is clamped within the limiting space, and the first guide rod 60 is fixedly disposed between the first sidewall 11 and the second sidewall 12, the first guide rod 60 limits an upward movement of the moving piece 23, and therefore, the mounting base 25 is only allowed to move up and down to a limited extent. The embodiment does not limit a connection manner between the first mounting plate 21 and the moving piece 23. For instance, the first mounting plate 21 is detachably connected to the moving piece 23 through at least one fastener, such as at least one screw. Alternatively, the first mounting plate 21 is fixedly connected to the moving piece 23 by welding, hot-melt fixing, etc., as long as normal operation of the moving assembly is ensured.

In one optional embodiment, one or more ribs vertically protrude from one side of the first mounting plate 21 facing the L-shaped baffle 211. Alternatively, one or more ribs vertically protrude from one side of the L-shaped baffle 211 facing the first mounting plate 21. The one or more ribs further enhance connection stability among the L-shaped baffle 211, the first mounting plate 21, and the first guide rod 60, and reduce vibration of the moving assembly.

In one optional embodiment, the transmission assembly 30 comprises a motor (not shown), a transmission belt 33, a driving wheel 31, and at least one driven wheel 32. The transmission belt 33 is in transmission connection with the driving wheel 31 and the at least one driven wheel 32. The motor is connected to an output shaft of the driving wheel 31. The motor is rotatable in a forward direction or a reverse direction, and the motor rotates to drive the driving wheel 31 to rotate, thereby driving the transmission belt 33 and the at least one driven wheel 32 to rotate.

In one optional embodiment, tooth grooves 331 are disposed on an inner side surface of the transmission belt 33. The moving assembly 20 further comprises a second mounting plate 22. Engaging teeth 221 are disposed on an inner side surface of the second mounting plate 22, and the second mounting plate 22 is disposed at a rear side of the moving piece 23. The second mounting plate 22 is connected to the moving piece 23 to define a positioning space. The transmission belt 33 passes through the positioning space, and the tooth grooves 331 of the transmission belt 33 are engaged with the engaging teeth 221 of the second mounting plate 22. In the embodiment, the transmission belt 33 is a synchronous belt, and the driving wheel 31 is a first synchronous gear. The at least one driven wheel comprises driven wheels 32, and at least one of the driven wheels 32 is a second synchronous gear. Through such configurations, transmission of the transmission assembly 30 is more precise, so that the movement of the moving assembly 20 is more precise, which facilitates the processing operation on the external workpiece.

In addition, the embodiment does not limit a connection manner between the second mounting plate 22 and the moving piece 23. For instance, the second mounting plate 22 is detachably connected to the moving piece 23 through at least one fastener, such as at least one screw. Alternatively, the second mounting plate 22 is fixedly connected to the moving piece 23 by welding, hot-melt fixing, etc., as long as the normal operation of the moving assembly is ensured.

An operating principle of the processing apparatus 100 of the present disclosure is as follows.

The processing apparatus 100 of the present disclosure achieves processing of the external workpiece in three dimensions. As shown in FIG. 1, the horizontal movement direction of the moving assembly 20 is defined as an X direction (i.e., a movement direction of the moving assembly 20 along the first guide rod 60 and the second guide rod 70); a direction in which the driving roller 80 rotates to drive the moving assembly 20 to displace up and down is defined as a Z direction; and a movement direction of the external workpiece is defined as a Y direction (i.e., a direction perpendicular to the conveying roller 50). In the pre-working state, the external workpiece is placed into the working area 46 and blocks the third sensor 43 and the fourth sensor 44. At this time, the conveying roller 50 rotates to draw in the external workpiece along the Y direction. When the external workpiece moves to the inner side of the working area 46 and blocks the fifth sensor 45, the conveying roller 50 stops rotating, and the processing apparatus 100 switches from the pre-working state to the working state. After entering the working state, the moving piece 23 is driven by the transmission assembly 30 to move in the X direction, and the driving roller 80 drives the tool 24 to move in the Z direction, thereby driving the blade to perform processing on the external workpiece in the X direction and the Z direction. When it is necessary to adjust the processing of the external workpiece in the Y direction, the conveying roller 50 rotates to adjust a processing orientation of the external workpiece in the Y direction. After completion of the adjustment, the moving assembly 20 resumes movement to start a new round of processing. In this way, the moving assembly 20, the conveying roller 50, and the driving roller 80 are controlled according to a processing pattern until the processing of the external workpiece is completed. Compared with the prior art, the moving assembly of the present disclosure does not strike against the first and second sidewalls during the processing, which reduces processing noise while improving processing accuracy and processing efficiency.

The processing apparatus 100 includes a housing 10, a cover plate 1001, a cavity 1002, an opening 1003, a worktable 40, a driving component 1000, a transmission assembly 30, a moving assembly 20, a conveying roller 50, a connecting rod 1006, a second guide rod 70, and a first guide rod 60. The housing 10 defines a cavity 1002 with an opening 1003 at the top. The cover plate 1001 is rotatably connected to the housing 10 to cover or open the opening 1003. The worktable 40 is located at the opening 1003 for placing workpieces to be processed.

The moving assembly 20 includes a moving piece 23, a vertically moving shell 1004, a tool 24, and a guide kit 1005. The moving piece 23 is connected to the second guide rod 70 and the first guide rod 60 and can move transversely along the two positioning rods. The driving component 1000 includes a drive rod 80. The drive rod 80 has a first end 81, a second end 82, a flat surface 83, an arc surface 84, an angular edge 85, a blocking portion 86, and teeth 87. The drive rod 80 passes through the moving assembly 20 and can drive the vertically moving shell 1004 to move vertically.

The moving assembly 20 is provided with a torsion component 1007, and the torsion component 1007 includes a first limiting portion 1019 and a second limiting portion 1020. The first limiting portion 1019 is provided with a first slot 1027, a second limiting boss 1029, a third limiting boss 1030, and a groove 1031. The second limiting portion 1020 is provided with a second slot 1028, a clamping block 1032, a sleeving structure 1033, a blocking structure 1034, a first limiting boss 1035, and a wall 1036. The wall 1036 includes a flat wall 10361 and an arc wall 10362. The arc wall 10362 is composed of a first arc segment 10362a, a second arc segment 10362b, and a third arc segment 10362c. The second limiting portion 1020 is further provided with a step structure 1039.

The torsion component 1007 further includes a sleeving portion 1021, and the sleeving portion 1021 includes a main body of the sleeving portion 1021a, a connection structure of the sleeving portion 1021b, and a clamping slot of the sleeving portion 1021c. The sleeving portion 1021 connects the first limiting portion 1019 and the second limiting portion 1020. The first limiting portion 1019, the second limiting portion 1020, and the sleeving portion 1021 together define a limiting space 1022. The limiting space 1022 receives a torsion spring 1008. The torsion spring 1008 has a first end of the torsion spring 1008a, a second end of the torsion spring 1008b, and a free end of the torsion spring 1008c. The two ends of the torsion spring 1008 are respectively fixed by the first slot 1027 and the second slot 1028.

The first limiting portion 1019 is provided with a first through hole 1024, the second limiting portion 1020 is provided with a second through hole 1025, and the sleeving portion 1021 is provided with a third through hole 1026. The three holes communicate to form a through space 1023 for the drive rod 80 to pass through. The free end of the torsion spring 1008c is connected to the guide kit 1005. When the drive rod 80 rotates, it drives the torsion spring 1008 to deform, thereby driving the vertically moving shell 1004 and the tool 24 to move vertically to cut workpieces. The conveying roller 50 is sleeved on the connecting rod 1006 and can rotate to suck and discharge materials. The transmission assembly 30 drives the moving assembly 20 to move transversely along the second guide rod 70 and the first guide rod 60.

The processing apparatus 100 includes a mounting member 90, a driving component 601, a mounting assembly 20, a guiding assembly 621, and a power assembly 600. The mounting member 90 is provided with a third accommodating space 910, a second accommodating space 920, a shaft hole 6301, a third wall 640, a fourth wall 650, a fifth wall 660, a fixing plate 670, a first fixing hole 671, a second fixing hole 672, and a fifth fixing hole 680. The driving component 601 includes a drive rod 80, a rod portion 602, an elastic member 603, and a torsion component 1007. The rod portion 602 includes a first segment 6021, a second segment 6022, and a third segment 6023. The second segment 6022 includes a first sub-segment 6022a, a second sub-segment 6022b, and a third sub-segment 6022c.

The elastic member 603 includes a first elastic portion 6031 and a second elastic portion 6032. The first elastic portion 6031 includes a first elastic structure 6031a and a first sleeve hole 6031b. The second elastic portion 6032 includes a second elastic structure 6032a and a second sleeve hole 6032b. The elastic member 603 further includes a connecting portion 6033. The connecting portion 6033 has an alternative structure 6034 including a first connecting portion 6034a and a second connecting portion 6034b. The elastic member 603 is fixed by a first fixing portion 6033a and a second fixing portion 6033b.

The torsion component 1007 includes a first limiting portion 1019 and a second limiting portion 1020. The first limiting portion 1019 includes a limiting platform 1019a and a limiting edge 1019b. The second limiting portion 1020 includes a limiting groove 1020a. The first limiting portion 1019 and the second limiting portion 1020 are connected via a sleeve portion 6043 and are respectively provided with a first slot 1027 and a second slot 1028, together defining a limiting space 618.

The mounting assembly 20 includes a mounting housing 23 and a tool 24. The mounting housing 23 includes a first housing portion 231 and a second housing portion 232. The second housing portion 232 is provided with a first accommodating space 2321, a fourth accommodating space 2322, a first wall 2323, a second wall 2324, a sixth wall 2325, a first restricting slot 2326, and a third restricting slot 2327.

The guiding assembly 621 includes a connecting member of the guiding assembly 6211, a guiding member of the guiding assembly 6212, and a fixing member of the guiding assembly 6213. The connecting member of the guiding assembly 6211 includes a connecting body 6211a, a first restricting portion 6211b, a second restricting portion 6211c, and a receiving slot 6211d. The guiding member of the guiding assembly 6212 includes a guiding body 6212a, a third restricting portion 6212b, and a fourth restricting portion 6212c. The guiding assembly 621 further includes a first guiding member 625 and a second guiding member 626. The first guiding member 625 is provided with a first guiding hole 6251 and a receiving slot 6252. The second guiding member 626 is provided with a second guiding hole 6261. The guiding assembly 621 further includes a first guide rod 60 and a second guide rod 70, as well as a fixing member for guiding member 627.

The housing 10 is provided at the top with a first cover plate 628 and a second cover plate 629. The first cover plate 628 is provided with a third fixing hole 6283 and a fourth fixing hole 8284. The first cover plate 628 and the second cover plate 629 are fixed by a second screw 6281 and a first screw 6282. The power assembly 600 includes a motor 630, a power shaft 631, and a first gear 632. A second gear 634 is connected to the drive rod 80 and meshes with the first gear 632. A control assembly 633 is electrically connected to the motor 630 to control the motor 630. The drive rod 80 can rotate in forward and reverse directions to drive the elastic member 603 to deform, thereby driving the mounting assembly 20 and the tool 24 to move. The guiding assembly 621 further includes an alternative structure 621A.

The belt tensioning mechanism 2000 includes a tensioning pulley 2001, a fixing member for belt tensioning 2002, an adjusting member 2004, a positioning member 2003, and a fastening member 2005. The tensioning pulley 2001 is provided at its center with a through hole of the tensioning pulley 2001a. The fixing member for belt tensioning 2002 includes a first fixing plate 2002a, a second fixing plate 2002b, and a third fixing plate 2002c. The first fixing plate 2002a is provided with a first sliding hole 2002d, the second fixing plate 2002b is provided with a second sliding hole 2002e, and the third fixing plate 2002c connects the first fixing plate 2002a and the second fixing plate 2002b. The fixing member for belt tensioning 2002 is further provided with a connecting plate 2002f. The connecting plate 2002f is provided with a connecting hole 2002g and a protruding clamping plate 2002h.

The positioning member 2003 includes a limiting block 2003a, an annular groove 2003b, and a clamping fastener 2003c. The positioning member 2003 sequentially passes through a first limiting hole of the adjusting member 2004d, the first sliding hole 2002d, the through hole of the tensioning pulley 2001a, the second sliding hole 2002e, and a second limiting hole of the adjusting member 2004e, connecting the tensioning pulley 2001 with the fixing member for belt tensioning 2002 and the adjusting member 2004.

The adjusting member 2004 includes a first adjusting plate 2004a, a second adjusting plate 2004b, and a third adjusting plate 2004c. The first adjusting plate 2004a is provided with a first limiting hole of the adjusting member 2004d. The second adjusting plate 2004b is provided with a second limiting hole of the adjusting member 2004e. The third adjusting plate 2004c is provided with an adjusting hole 2004f. The adjusting member 2004 is further provided with a notch 2004g. The fastening member 2005 passes through the adjusting hole 2004f and abuts against the fixing member for belt tensioning 2002. By rotating the fastening member 2005, the distance between the adjusting member 2004 and the fixing member for belt tensioning 2002 can be adjusted, causing the tensioning pulley 2001 to move with the adjusting member 2004.

The fixing member for belt tensioning 2002 is fixed to an external frame via a connecting member for belt tensioning 2006. The transmission assembly 30 includes a transmission belt 33, a driving wheel 31, and a driven wheel 32. The transmission belt 33 has tooth grooves 331 and a smooth surface of the belt 332. The tooth grooves 331 are in meshing connection with the tensioning pulley 2001 and the driving wheel 31. The smooth surface of the belt 332 is connected to the driven wheel 32. By rotating the fastening member 2005, the position of the tensioning pulley 2001 can be adjusted to keep the transmission belt 33 in a tensioned state.

The above are only optional embodiments of the present disclosure and specifically depict technical principles of the present disclosure. These descriptions are only for explaining the principles of the present disclosure, and cannot be interpreted as limiting of the protection scope of the present disclosure in any way. Based on the explanations, any modification, equivalent replacement, and improvement made within the spirit and principle of the disclosure, and other specific implementations of the present disclosure obtained by those skilled in the art without creative work, should fall within the protection scope of the present disclosure.

What is claimed is:

1. A processing apparatus, comprising: a housing, a first sensor, a second sensor, a transmission assembly, and a moving assembly;
wherein the housing comprises a first sidewall, a second sidewall, and a third sidewall, wherein the first sidewall and the second sidewall are disposed opposite to each other, and the third sidewall connects the first sidewall and the second sidewall;
wherein the first sensor and the second sensor are disposed on the third sidewall, the first sensor is adjacent to the first sidewall, and the second sensor is adjacent to the second sidewall;
wherein the transmission assembly is drivingly connected to the moving assembly, and the transmission assembly is configured to drive the moving assembly to move between the first sidewall and the second sidewall;
wherein when the moving assembly moves to a position directly in front of the first sensor, the first sensor is blocked, and the processing apparatus controls the moving assembly to stop moving toward the first sidewall; and
when the moving assembly moves to a position directly in front of the second sensor, the second sensor is blocked, and the processing apparatus controls the moving assembly to stop moving toward the second sidewall.

2. The processing apparatus according to claim 1, wherein when the moving assembly moves to the position directly in front of the first sensor, the first sensor is blocked, and the processing apparatus controls the moving assembly to stop moving toward the first sidewall and controls the moving assembly to stop or controls the moving assembly to move toward the second sidewall; and
when the moving assembly moves to the position directly in front of the second sensor, the second sensor is blocked, and the processing apparatus controls the moving assembly to stop moving toward the second sidewall and controls the moving assembly to stop or controls the moving assembly to move toward the first sidewall.

3. The processing apparatus according to claim 1, wherein the processing apparatus further comprises a worktable, the housing is connected to the worktable, a first limiting portion and a second limiting portion are disposed on the worktable, and the first limiting portion and the second limiting portion are opposite to each other to define a working area of the worktable;
wherein the first limiting portion comprises a first limiting plate, the second limiting portion comprises a second limiting plate, the first limiting plate is disposed on one side of the first limiting portion and extends toward the second limiting portion, and the second limiting plate is disposed on one side of the second limiting portion and extends toward the first limiting portion.

4. The processing apparatus according to claim 3, wherein a predetermined distance is defined between the working area and each of the first limiting plate and the second limiting plate, and the first limiting plate and the second limiting plate are configured to limit a thickness of an external workpiece entering the working area.

5. The processing apparatus according to claim 3, wherein the processing apparatus further comprises a third sensor, a fourth sensor, and a conveying roller;
wherein the third sensor, the fourth sensor, and the conveying roller are disposed on the worktable;
wherein the third sensor is located below the first limiting plate, the fourth sensor is located below the second limiting plate, and the conveying roller is disposed adjacent to the working area, the processing apparatus has a pre-working state and a working state, and the processing apparatus is switchable between the pre-working state and the working state;
wherein when the processing apparatus is in the pre-working state, and when the external workpiece enters the working area and blocks the third sensor and the fourth sensor, the conveying roller rotates in a forward direction to draw in the external workpiece and drive the external workpiece to move.

6. The processing apparatus according to claim 5, wherein two ends of the conveying roller are respectively connected to the first sidewall and the second sidewall, a fifth sensor is disposed on the working area, and the fifth sensor is close to an inner side of the working area;
wherein when the processing apparatus is in the pre-working state, and when the external workpiece enters the working area and blocks the third sensor and the fourth sensor, the conveying roller rotates to draw in and convey the external workpiece;
wherein when the external workpiece is conveyed to the inner side of the working area and blocks the fifth sensor, the processing apparatus controls the conveying roller to stop rotating; and when the fifth sensor is blocked for a predetermined time, the processing apparatus switches from the pre-working state to the working state, and the conveying roller is switchable among three states of forward rotation, reverse rotation, and non-rotation.

7. The processing apparatus according to claim 1, wherein the processing apparatus further comprises a first guide rod, a driving roller, and a second guide rod;
wherein the first guide rod, the driving roller, and the second guide rod are parallel to each other and are disposed from top to bottom, two ends of the first guide rod are respectively connected to the first sidewall and the second sidewall, two ends of the second guide rod are respectively connected to the first sidewall and the second sidewall, and two ends of the driving roller are respectively rotatably connected to the first sidewall and the second sidewall;
wherein the moving assembly is movably connected to the first guide rod and the second guide rod, the first guide rod is located at a rear side of the moving assembly, and the moving assembly is movable along the first guide rod, the driving roller, and the second guide rod.

8. The processing apparatus according to claim 7, wherein the moving assembly comprises a moving piece, a tool, and a mounting base;
wherein the driving roller and the second guide rod pass through the moving piece, the moving piece is movably connected to the mounting base, and the tool is clamped in the mounting base;
wherein the driving roller rotates to drive the mounting base to move up and down, thereby causing the tool to move up and down, and during a movement of the moving assembly, an orthographic projection of the tool always falls within the working area.

9. The processing apparatus according to claim 7, wherein the moving assembly further comprises an L-shaped baffle, the L-shaped baffle is disposed at an upper portion of one side of the moving assembly close to the third sidewall, the L-shaped baffle and the one side of the moving assembly close to the third sidewall jointly define a limiting space, and a portion of the first guide rod is clamped within the limiting space.

10. The processing apparatus according to claim 7, wherein the transmission assembly comprises a motor, a transmission belt, a driving wheel, and at least one driven wheel, the transmission belt is drivingly connected to the driving wheel and the at least one driven wheel, and the motor is connected to an output shaft of the driving wheel;
wherein the motor is rotatable in a forward direction or a reverse direction, and the motor rotates to drive the driving wheel to rotate, thereby driving the transmission belt and the at least one driven wheel to rotate;
wherein tooth grooves are disposed on an inner side surface of the transmission belt, the moving assembly further comprises a second mounting plate, engaging teeth are disposed on an inner side surface of the second mounting plate, and the second mounting plate is disposed at a rear side of the moving piece;
wherein the second mounting plate is connected to the moving piece to define a positioning space, the transmission belt passes through the positioning space, and the tooth grooves of the transmission belt are engaged with the engaging teeth of the second mounting plate.
